(19) United States
(12) Patent Application Publication
(10) Pub. No.: US 2006/0203860 A1
(43) Pub. Date: Sep. 14, 2006

(54) Laser device and laser module

(75) Inventors: Kenichi Inoue, Osaka (JP); Kazuhiko Yamanaka, Palo Alto, CA (US); Kazutoshi Onozawa, Osaka (JP); Daisuke Ueda, Osaka (JP)

Correspondence Address: HAMRE, SCHUMANN, MUELLER & LARSON P.C., P.O. BOX 2902-0902, MINNEAPOLIS, MN, 55402, US

(73) Assignee: MATSUSHITA ELECTRIC INDUSTRIAL CO., LTD., Kadoma-shi (JP)

(21) Appl. No.: 11/352,948

(22) Filed: Feb. 13, 2006

(30) Foreign Application Priority Data
Feb. 14, 2005 (JP) 2005-035993
Jul. 4, 2005 (JP) 2005-195308

(51) Int. Cl. H01S 3/10

(52) U.S. Cl. 372/23

(57) ABSTRACT

A laser module includes a substrate 1, a first laser element 2 placed on the substrate 1, a second laser element 3 placed with an output surface opposed to the first laser element 2 on the substrate 1, and a mirror 7 placed between the first laser element 2 and the second laser element 3. The mirror 7 has a reflective surface capable of reflecting output light from the first laser element 2 or the second laser element 3 in a predetermined direction, and is placed so as to move or rotate between a first position capable of reflecting the output light from the first laser element 2 and a second position capable of reflecting the output light from the second laser element 3. Thus, a laser module can be provided in which high precision, low cost, and miniaturization can be realized.

### BACKGROUND OF THE INVENTION

1. Field of the Invention

The present invention relates to a laser module capable of writing or reading information on an optical disk.

2. Description of Related Art

Optical disks have increased rapidly in a recording capacity, and not only an existing compact disk (CD) and digital versatile disk (DVD), but also a high definition (HD)-DVD that is a next-generation optical disk currently are being developed. An optical disk apparatus capable of writing and reading information with respect to these optical disks also is being developed. More specifically, in the case of writing and reading information with respect to a CD, a DVD, and an HD-DVD, laser light in each wavelength range, such as infrared light (λ=780 nm), red light (λ=650 nm), and blue light (λ=405 nm) are required. In the business world, a disk apparatus in which a semiconductor laser chip capable of emitting laser light in each wavelength range is mounted is being developed.

A laser module (hybrid type multi-wavelength-compatible laser module) with a plurality of laser chips mounted thereon can be realized by forming minute protrusions on a substrate on which each laser chip is to be mounted, placing mirrors on inclined surfaces of each minute protrusion, and placing a plurality of laser chips on the substrate so that the inclined surface is opposed to an output end surface of each laser chip. Such a configuration is disclosed by, for example, Patent Document 1 (JP 2002-269798 A).

FIG. 40 is a side view showing a configuration of a conventional multi-wavelength laser module. As shown in FIG. 40, a module 108 having a multi-wavelength light source is configured on a semiconductor substrate 103 made of silicon (Si) so as to include a first semiconductor laser chip 101 and a second semiconductor laser chip 102 placed so as to be opposed to each other, a minute protrusion 104 placed between the first laser chip 101 and the second laser chip 102, and a photodetector 107 composed of a light-receiving region 105 and an electrode 106.

The minute protrusion 4 is obtained by subjecting silicon to anisotropic etching, and is capable of reflecting incident light beams in a substantially vertical direction with respect to the substrate 3 by reflecting them by reflective surfaces 104a, 104b.

However, in the multi-wavelength laser module shown in FIG. 40, the optical axes of light beams output from the respective laser chips 101 and 102 and reflected by the minute protrusion 104 do not coincide with each other, and when the light beams are condensed by an objective lens (not shown), an aberration occurs. This consequently degrades light detection precision.

Furthermore, in order to allow the optical axes of the light beams to coincide with each other, a new optical component for shifting the optical axes is required, which enlarges the laser module and a pickup, resulting in an increase in cost.

### SUMMARY OF THE INVENTION

The object of the present invention is to provide a laser module in which high precision, low cost, and miniaturization can be realized.

In order to solve the above-mentioned problem, a first configuration of a laser module includes: a substrate; a first laser element placed on the substrate; a second laser element placed with an output surface opposed to the first laser element on the substrate; and a reflector placed between the first laser element and the second laser element, wherein the reflector has a reflective surface capable of reflecting output light from the first laser element or the second laser element in a predetermined direction, and the reflector is placed so as to move or rotate between a first position capable of reflecting the output light from the first laser element and a second position capable of reflecting the output light from the second laser element.

Furthermore, a second configuration of a laser module of the present invention includes: a laser element; and a reflector configured by connecting a first reflective surface to a second reflective surface with an intersection line, and placed so as to reflect laser light output from the laser element by the first and second reflective surfaces, wherein the reflector is placed at a position where the first reflective surface crosses a first optical axis of laser light output from the laser element, and the second reflective surface crosses a second optical axis of laser light reflected by the first reflective surface.

### BRIEF DESCRIPTION OF THE DRAWINGS

FIG. 1 is a perspective view showing a configuration of a laser module in Embodiment 1.

FIG. 2 is a cross-sectional view taken along a line A-A′ in FIG. 1.

FIG. 3 is a cross-sectional view showing a state in which a light beam output from a first laser chip is reflected.

FIG. 4 is a cross-sectional view showing a state in which a light beam output from a second laser chip is reflected.

FIG. 5 is a schematic view illustrating a rotation operation of a mirror.

FIG. 6 is a schematic view illustrating a rotation operation of the mirror.

FIG. 7 is a plan view illustrating a configuration of the mirror.

FIG. 8A is a cross-sectional view illustrating a method for producing a coil substrate.

FIG. 8B is a cross-sectional view illustrating the method for producing the coil substrate.

FIG. 9A is a cross-sectional view illustrating a method for producing a mirror substrate.

FIG. 9B is a cross-sectional view illustrating the method for producing the mirror substrate.

FIG. 10A is a cross-sectional view illustrating a method for producing a bearing substrate.

FIG. 10B is a cross-sectional view illustrating the method for producing the bearing substrate.

FIG. 11A is a cross-sectional view illustrating a method for producing a substrate.

FIG. 11B is a cross-sectional view illustrating the method for producing the substrate.

FIG. 12A is a cross-sectional view illustrating a method for producing a laser module.

FIG. 12B is a cross-sectional view illustrating the method for producing the laser module.

FIG. 13A is a cross-sectional view illustrating the method for producing the laser module.

FIG. 13B is a cross-sectional view illustrating the method for producing the laser module.

FIG. 14 is a cross-sectional view showing a configuration of a laser module in Embodiment 2.

FIG. 15 is a cross-sectional view showing a state in which a light beam output from a first laser chip is reflected.

FIG. 16 is a cross-sectional view showing a state in which a light beam output from a second laser chip is reflected.

FIG. 17 is a cross-sectional view illustrating a method for producing a lower electrode substrate.

FIG. 18 is a cross-sectional view illustrating the method for producing the lower electrode substrate.

FIG. 19 is a cross-sectional view illustrating the method for producing the lower electrode substrate.

FIG. 20 is a cross-sectional view illustrating a method for producing a movable platform and a protruding mirror.

FIG. 21 is a cross-sectional view illustrating the method for producing the movable platform and the protruding mirror.

FIG. 22 is a cross-sectional view illustrating the method for producing the movable platform and the protruding mirror.

FIG. 23 is a cross-sectional view illustrating the method for producing the movable platform and the protruding mirror.

FIG. 24 is a cross-sectional view illustrating the method for producing the movable platform and the protruding mirror.

FIG. 25 is a perspective view of a laser device with a dihedral reflector mounted thereon according to Embodiment 3.

FIG. 26 is a cross-sectional view of the laser device.

FIG. 27 is a cross-sectional view of the laser device.

FIG. 28 is a schematic view illustrating a reflection angle of a light beam in the laser device.

FIG. 29 is a cross-sectional view illustrating a method for producing the reflector.

FIG. 30 is a cross-sectional view illustrating the method for producing the reflector.

FIG. 31 is a cross-sectional view illustrating the method for producing the reflector.

FIG. 32 is a cross-sectional view illustrating the method for producing the reflector.

FIG. 33 is a cross-sectional view illustrating the method for producing the reflector.

FIG. 34 is a cross-sectional view of a laser device equipped with a slide mechanism according to Embodiment 4.

FIG. 35 is a cross-sectional view of a multi-wavelength laser device equipped with a slide mechanism according to Embodiment 5.

FIG. 36 is a cross-sectional view of a multi-wavelength laser device equipped with a rotation mechanism according to Embodiment 6.

FIG. 37 is a cross-sectional view of a multi-wavelength laser device according to Embodiment 7.

FIG. 38 is a cross-sectional view illustrating a shape of a reflector according to Embodiment 6.

FIG. 39 is a cross-sectional view illustrating the shape of the reflector.

FIG. 40 is a perspective view showing a configuration of a conventional laser device.

### DETAILED DESCRIPTION OF THE INVENTION

In a first configuration of a laser module of the present invention, it is preferable that the reflector is placed rotatably, and an angle through which the reflective surface rotates from a posture capable of reflecting the output light from the first laser element to a posture capable of reflecting the output light from the second laser element is at least 45°.

Furthermore, it is preferable that the substrate has a bearing structure, the reflector has a rotation shaft supported rotatably by the bearing structure, and the reflector moves rotatably between the first position and the second position.

Furthermore, it is preferable that the bearing structure is formed by bonding the first substrate to the second substrate, and a concave portion receiving the rotation shaft is formed on at least one of the first substrate and the second substrate.

Furthermore, it is preferable that the reflector is composed of a magnetic substance partially or wholly.

Furthermore, it is preferable that the reflector is formed integrally with the rotation shaft, and a width of the rotation shaft is formed so as to become large toward a portion close to the reflector.

Furthermore, it is preferable that the substrate has a protrusion with an inclined surface in a lower part of the reflector, and the reflector is in surface contact with the inclined surface when the reflector is placed at the first position or the second position.

Furthermore, it is preferable that a low-friction material adheres to at least one of the bearing structure and the rotation shaft.

Furthermore, it is preferable that the laser module includes: a substrate; a first laser element placed on the substrate; a second laser element placed with an output surface opposed to the first laser element on the substrate; a movable portion placed between the first laser element and the second laser element; and a reflector in a protrusion shape that is placed in the movable portion and has reflective surfaces opposed to the output surfaces of the first laser element and the second laser element on both sides, wherein the movable portion is configured rotatably so that reflected light which is output from the first laser element or the second laser element and reflected by the reflective surface is in an identical direction and has an identical optical axis.

Furthermore, it is preferable that the substrate is configured by bonding the first substrate to the second substrate, the movable portion, a beam, and the reflector are formed on the first substrate, and a support portion supporting the beam and the movable portion is formed on the second substrate.

Furthermore, it is preferable that the first substrate is made of silicon, and the reflector is formed by crystal anisotropic etching.

In a second configuration of a multi-wavelength laser module of the present invention, it is preferable that an angle formed by the first reflective surface and the second reflective surface is 135°.

Furthermore, it is preferable that an angle formed by the first reflective surface and the second reflective surface is 135° on a plane including the first optical axis and the second optical axis.

Furthermore, it is preferable that the reflector is supported rotatably by a shaft, the shaft is parallel to the first and second reflective surfaces, a rotation axis of the shaft is positioned on the first optical axis, and the rotation axis of the shaft further is positioned on a third optical axis of the laser light reflected by the second reflective surface.

Furthermore, it is preferable that the reflector is placed on a rotatable rotation member, and a rotation axis of the rotation member coincides with the third optical axis vertical to the first optical axis.

Furthermore, it is preferable that the reflector is placed on a moving member movable in parallel with the first optical axis.

Furthermore, it is preferable that the reflector is made of silicon, the first reflective surface is composed of a silicon polished surface, and the second reflective surface is formed by anisotropic etching.

Furthermore, it is preferable that laser module includes a plurality of laser elements, and the plurality of laser elements are placed with output surfaces of laser light directed to the reflector side.

Furthermore, it is preferable that assuming that a distance between a light emitting point of the laser element and the first reflective surface is d1, and an optical path length from the light emitting point of the laser element to the second reflective surface is d2, a ratio of a length of an intersection line where a plane including the second optical axis crosses the second reflective surface, with respect to a length of an intersection line where a plane including the first optical axis crosses the first reflective surface is at least d2/d1.

### Embodiment 1

1. Configuration of a Laser Module

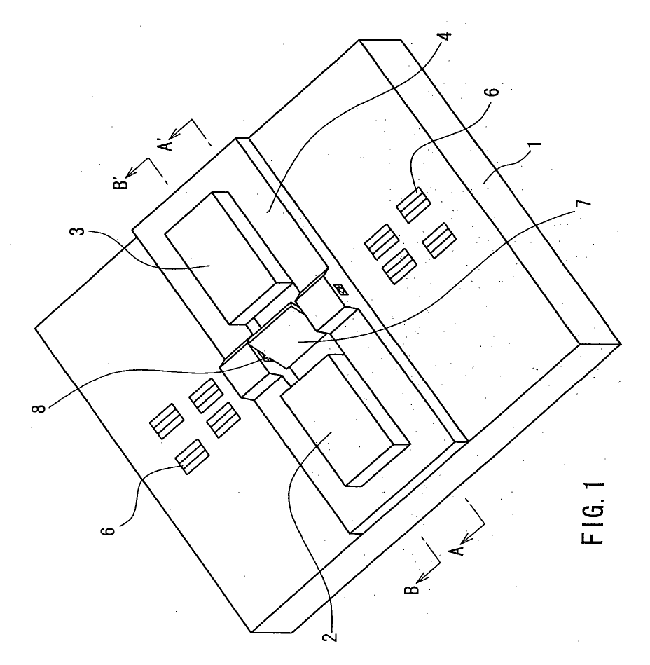

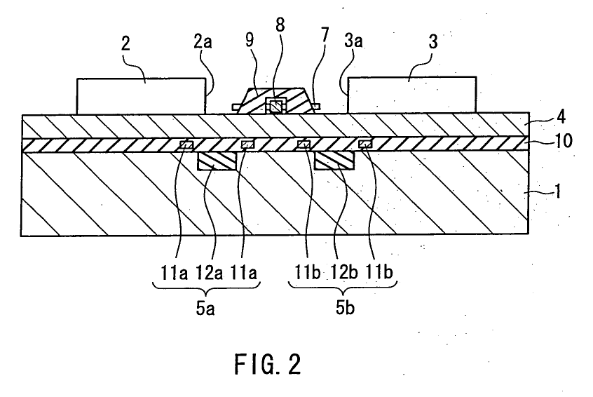

FIG. 1 is a perspective view showing a `configuration of a multi-wavelength laser module in Embodiment 1. FIG. 2 is a cross-sectional view taken along a line A-A′ in FIG. 1.

The multi-wavelength laser module shown in FIGS. 1 and 2 is composed of a first laser chip 2, a second laser chip 3, a mirror 7, magnetism generating circuits 5a and 5b, and a photodetector 6. The first laser chip 2, the second laser chip 3, and the mirror 7 are placed on a stage 4 formed on a substrate 1. The magnetism generating circuits 5a and 5b, and the photodetector 6 are placed on the substrate 1. Furthermore, the stage 4 preferably is made of a material with a high heat conductivity from which a heat sink effect is obtained.

The first laser chip 2 and the second laser chip 3 are placed so that respective output surfaces 2a and 3a are opposed to each other. Furthermore, the mirror 7 is placed between the laser chips 2 and 3.

The mirror 7 is composed of a magnetic substance wholly or partially. Furthermore, a rotation shaft 8 is placed so as to be integrated with the mirror 7, and the rotation shaft 8 is supported rotatably by a bearing 9. Thus, the mirror 7 is rotated by being attracted to, for example, one magnetic field of the two magnetism generating circuits 5a and 5b placed below the mirror 7. This can vary the inclination angle of the mirror 7, and enables the reflective surface of the mirror 7 to be opposed to the output surface of the first laser chip 2 or the second laser chip 3.

The magnetism generating circuit 5a is placed at a position close to the first laser chip 2 in a rotation end portion of the mirror 7. Furthermore, the magnetism generating circuit 5b is placed at a position close to the second laser chip 3 in the rotation end portion of the mirror 7. The magnetism generating circuit 5a is composed of magnetic substances 12a and 12b, and coils 11a and 11b with the magnetic substances 12a and 12b being centers, and the surface of the magnetism generating circuit 5a opposed to the mirror 7 is covered with an insulating film 10. In the above configuration, a magnetic field is generated on the periphery of the magnetic substance 12a or 12b by energizing the coils 11a or 11b, whereby the rotation end of the mirror 7 can be attracted. Although coil wiring constituting the magnetism generating circuits 5a and 5b is subjected to line and layer insulation with the insulating film 10, the uppermost surface of the coil wiring is not necessarily covered with the insulating film 10.

2. Operation

2-1. Operation of the Laser Module

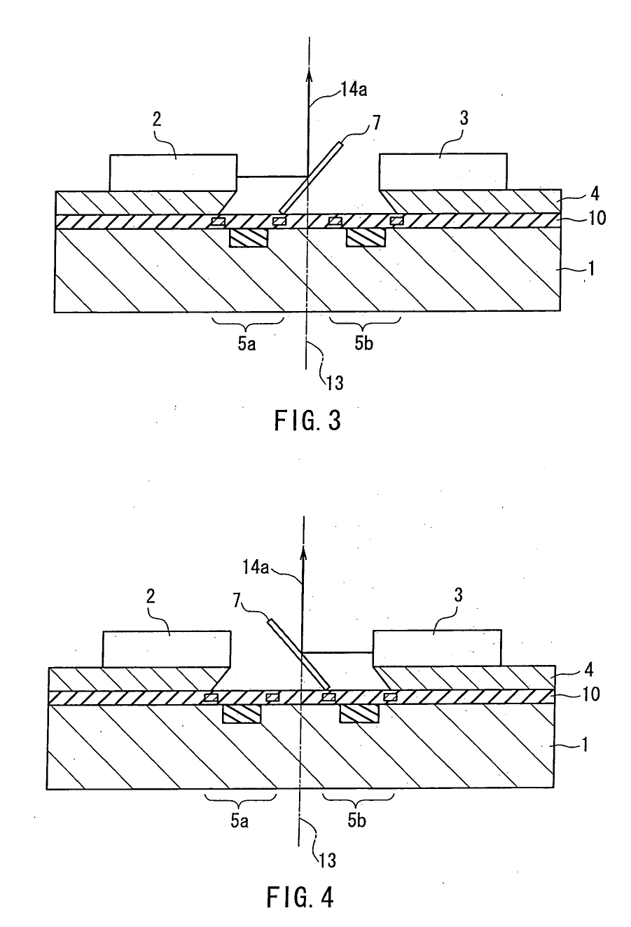

FIGS. 3 and 4 are cross-sectional views taken along a line B-B′ in FIG. 1. FIG. 3 shows a state in which output light from the first laser chip 2 is reflected by the mirror 7. FIG. 4 shows a state in which output light from the second laser chip 3 is reflected by the mirror 7.

First, in the case where a magnetic substance constituting the mirror 7 is a soft magnetic substance, as shown in FIG. 3, when a magnetic field is generated by allowing a current to flow through the magnetism generating circuit 5a, the mirror 7 is attracted to the magnetic field in the magnetism generating circuit 5a to cause a torque around the rotation shaft 8, whereby the reflective surface is rotated to a position opposed to the output surface 2a of the laser chip 2. In the state shown in FIG. 3, if the angle of the rotated mirror 7 is controlled so as to be 45° with respect to the axis of the output light from the laser chip 2, a light beam 14a output from the laser chip 2 can coincide with a principal axis 13. Examples of the rotation control of the mirror 7 include a method for controlling an inclination angle to be 45° by feedback control, and a method for controlling an inclination angle to be 45° by providing a mechanism capable of being positioned with a rotation angle of 45°.

Next, as shown in FIG. 4, if a current is allowed to flow through the magnetism generating circuit 5b, the mirror 7 causes a torque around the rotation shaft 8 due to the magnetic field generated from the magnetism generating circuit 5b, and the reflective surface is rotated to a position opposed to the output surface 3a of the laser chip 3. At this time, if the angle of the reflective surface of the mirror 7 is set to be 45° with respect to the axis of the output light from the laser chip 3, a light beam 14b output from the laser chip 3 and reflected by the mirror 7 can coincide with the principal axis 13.

Thus, when either one of the laser chips 2 and 3 is operated selectively, either one of the magnetism generating circuits 5a and 5b is operated, whereby the mirror 7 can be rotated, and a light beam output from the laser chip 2 or 3 can be reflected in a vertical direction. Consequently, the light beams 14a and 14b reflected by the mirror 7 can coincide with the principal axis 13.

2-2. Rotation and Fixing Operation of the Mirror 7

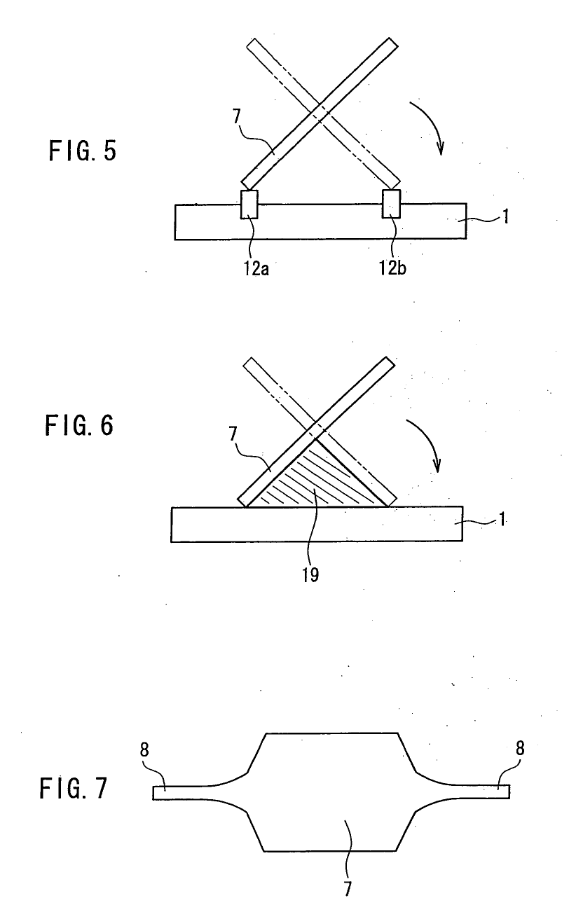

FIGS. 5 and 6 are schematic views showing a rotation operation of the mirror 7. FIG. 7 is plan view of the mirror 7.

The mirror 7 is made of a material containing a hard magnetic substance, and previously magnetized to be a magnet. Such a mirror 7 can be rotated in a direction represented by an arrow or a direction opposite thereto, by allowing a current to flow through one circuit among a plurality of magnetism generating circuits (not shown). When the mirror 7 is rotated to come into contact with a magnetic core 12a or 12b, the mirror 7 can be held under the condition of being inclined at an angle of 45°. At this time, the magnetic cores 12a, 12b are magnetized by the magnet constituting the mirror 7. Therefore, even if the energization of the magnetism generating circuit is interrupted, the mirror 7 and the magnetic core 12a or 12b maintain an attraction state, and the mirror 7 can remain being inclined at an angle of 45°.

Herein, if the size of the mirror 7 or the size of the magnetic cores 12a, 12b are adjusted so that the mirror 7 is inclined at a desired angle, the mirror 7 can be maintained at a predetermined angle.

The “contact” in the present invention is not limited to the state (attraction) in which the magnet constituting the mirror 7 is in direct contact with the magnetic core 12a (or 12b), and also includes a state in which the magnet and the magnetic core 12a (or 12b) are attracted by a magnetic force, and a part of the mirror 7 is in contact with the substrate 1.

Furthermore, in the case of a configuration in which a part of the mirror 7 is a magnet, the mirror 7 and the magnetic core 12a (or 12b) are attracted to each other by an attraction force, so that they are unlikely to be influence by external perturbations. In the case where the attraction state is cancelled to be shifted to another state, a current may be allowed to flow through a side of the magnetism generating circuit (e.g., 12a) opposed to the mirror 7 so that a magnetic pole opposite to that of the mirror 7 is generated. Furthermore, when the magnetism generating circuit (e.g., 12b) forming a pair is energized so that a magnetic pole exerting an attraction force between the mirror 7 and the magnetism generating circuit 12b is formed, a shift of the state further becomes easy.

Furthermore, as shown in FIG. 6, for example, a protrusion 19 in a right-angled isosceles triangle shape is formed below the mirror 7, the mirror 7 is composed of a magnetic substance partly or wholly, and the protrusion 19 is composed of a magnetic substance partly or wholly, whereby the magnetic substance of the mirror 7 and the protrusion 19 are both magnetized to generate an attraction force with the magnetic field generated by the magnetism generating circuit (not shown in FIG. 6). Consequently, the mirror 7 and the protrusion 19 can be fixed while they are in surface contact with each other.

Furthermore, if the mirror 7 partly or wholly is composed of a magnetic substance with a conductive magnetic substance or a conductive portion configured on the periphery, and a part (surface) or an entirety of the protrusion 19 is composed of a conductor, an electrostatic attraction force is generated therebetween by applying a voltage between the mirror 7 and the conductive portion of the protrusion 19, whereby they are brought into surface contact with each other to be fixed. In this configuration, at least one of the mirror 7 and the conductor of the protrusion 19 should be covered with a thin insulating layer so that they do not come into electrical contact with each other.

3. Method for Producing a Laser Module

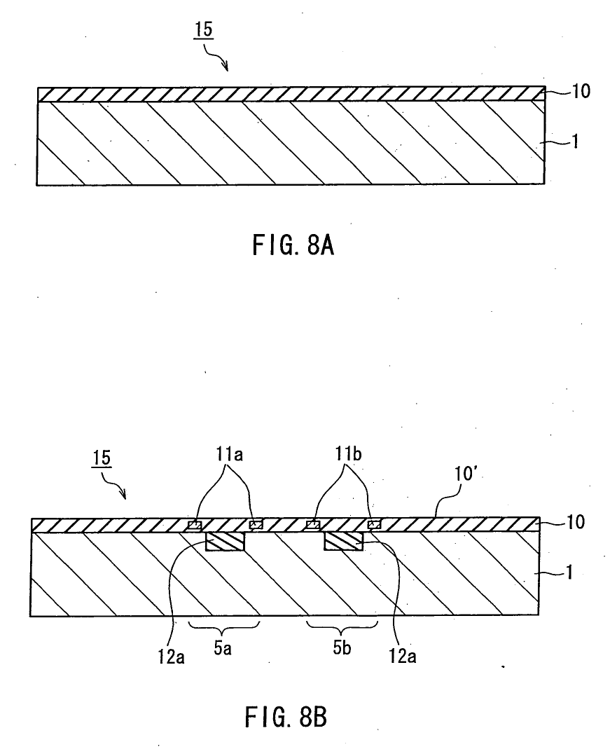

FIGS. 8A to 13B are cross-sectional views showing a production process of a laser module on the step basis. FIGS. 8A, 9A, 10A, 11A, 12A, and 13A show cross-sections taken along the line A-A in FIG. 1. Furthermore, FIGS. 8B, 9B, 10B, 11B, 12B, and 13B show cross-sections taken along the line B-B′ in FIG. 1.

Hereinafter, unless otherwise specified, the principal plane of a semiconductor substrate is set to be a (001) plane, and the taper angle formed by anisotropic etching with a KOH aqueous solution is set to be about 54.7° that is an angle formed with a (111) plane.

First, FIGS. 8A and 8B show steps of producing the coils 11a, 11b on the substrate 1. In FIGS. 8A and 8B, concave portions are formed on the substrate 1 (e.g., a silicon substrate) by etching. In the formed concave portions, the magnetic cores 12a, 12b composed of a magnetic substance are deposited as shown in FIG. 8B. The magnetic cores 12a, 12b can be formed by sputtering, vapor deposition, or electrolytic plating. It is preferable that the magnetic substance material for the magnetic cores 12a and 12b are made of a soft magnetic material such as nickel (Ni) or permalloy (FeNi). The magnetic cores 12a and 12b may be placed so as to be present in the vicinity of a magnetism generating circuit and to be magnetized by a generated magnetic field, and are not required to be placed at the centers of the coils 11a and 11b.

Next, an insulating layer 10 is formed on the substrate 1 to insulate the substrate 1. The insulating layer 10 can be composed of a material with a low dielectric constant such as a silicon oxide film, a silicon nitride film, or resin.

Next, the coils 11a, 11b are formed of metal wiring on the insulating layer 10. The metal wiring can be formed by electrolytic plating. Furthermore, the metal wiring is made of a material such as copper (Cu), gold (Au), or aluminum (Al). The magnetic cores 12a, 12b are magnetized by allowing a current to flow through the coils 11a, 11b, respectively, whereby a magnetic field is amplified. The magnetic cores 12a, 12b are not necessarily required to be provided. A rotator can be rotated only by energizing the coils 11a, 11b. However, by providing the magnetic cores 12a, 12b, the mirror 7 can be held at a predetermined angle, using an attraction force generated between the magnetic cores and the hard magnetic substance (magnet).

The hard magnetic substance is composed of, for example, cobalt (Co), a cobalt-platinum alloy (CoPt) that is a cobalt-based alloy, a cobalt-nickel alloy (CoNi), or a cobalt-phosphorus alloy (CoP).

Next, as shown in FIG. 8B, an insulating layer 10′ is formed so as to cover the magnetism generating circuits 5a, 5b, and the magnetism generating circuits 5a, 5b are buried, whereby a substrate 15 is formed. The insulating layer 10′ can be made of a material similar to that of the insulating layer 10. Furthermore, in the case of providing a multi-layered magnetism generating circuit, the above-mentioned stacking treatment may be repeated.

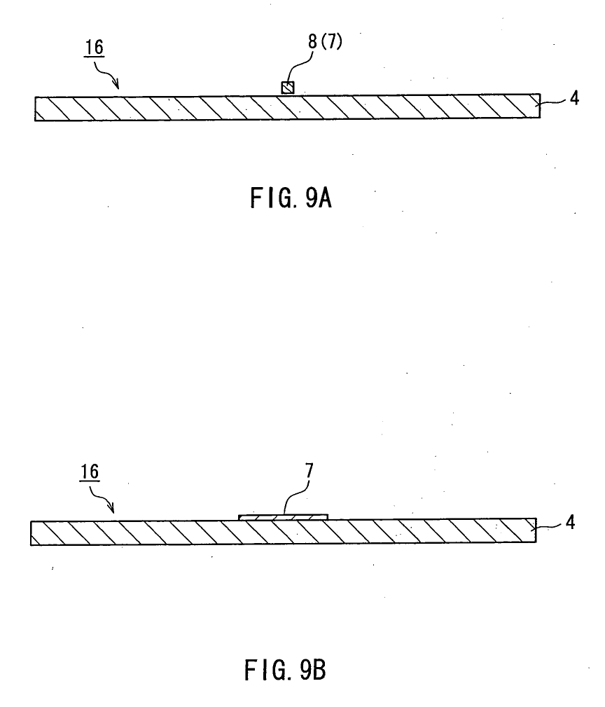

FIGS. 9A and 9B are cross-sectional views showing a method for producing the substrate 16 with the mirror 7.

As shown in FIGS. 9A and 9B, first, an electrode is vapor-deposited for electrolytic plating on a substrate 4, and the resultant substrate 4 is coated with a photoresist and patterned to the shape of the mirror 7 by photolithography. If a magnetic substance is subjected to electrolytic plating, and the photoresist is removed in this state, the mirror 7 in a desired shape is formed. The magnetic substance is made of, for example, nickel (Ni) or permalloy (FeNi). Furthermore, if a rotation shaft 8 is formed integrally in the course of the formation of the mirror 7, a magnetic substance mirror with a rotation axis can be produced.

As shown in FIG. 7, the rotation shaft 8 is formed so that its width becomes larger toward the mirror 7, the concentration of stress in a connection portion between the mirror 7 and the rotation shaft 8 can be alleviated to enhance the strength. Furthermore, it is preferable that the rotation shaft 8 and the mirror 7 are connected to each other smoothly as shown in FIG. 7 in terms of the stability with respect to a rotation runout. Furthermore, if a sacrificial layer (a photoresist, a silicon oxide film, etc.) is provided only in an underlying portion of the rotation axis of the mirror 7 in the course of the formation of the mirror 7 by electrolytic plating, the rotation shaft 8 and the substrate 4 can be put in a non-fixed state by selectively removing the sacrificial layer after electrolyte plating. Furthermore, by adjusting the thickness of the sacrificial layer, the distance between the center axis of the rotation shaft 8 and the reflective surface of the mirror 7 can be adjusted. Therefore, even in the case where light output from a laser chip is not reflected on a horizontal center line (symmetrical line), reflection points of light beams output from the first laser chip 2 and the second laser chip 3 can coincide with each other completely.

Furthermore, an underlying electrode surface in plating has very satisfactory surface flatness, reflecting the underlying flatness, so that this surface may be used as a mirror. In this case, although not shown in the figure, a process (a mounting position of a laser chip, etc.) may be changed so that the front and back of the substrate 4 are reversed.

In the above step, the substrate 16 with the mirror 7 formed thereon can be produced.

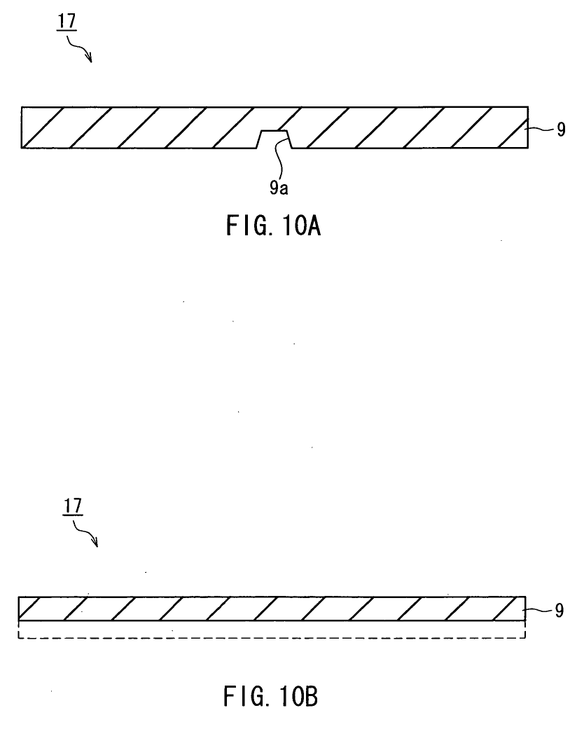

FIGS. 10A and 10B are cross-sectional views showing a method for producing a substrate 17 with a bearing.

As shown in FIGS. 10A and 10B, a concave portion 9a to be a bearing of the rotation shaft 8 is formed on a semiconductor substrate 9 (e.g., a silicon substrate). The concave portion 9a can be produced by photolithography and etching.

At this time, by patterning a photoresist to the shapes of the entire mirror 7 including the rotation shaft 8 and a laser chip mounting portion, a space for rotating the mirror 7 can be produced. Thus, the substrate 17 with the bearing formed thereon can be produced.

Herein, by depositing a material with a low friction such as a silicon nitride film thinly in the concave portion 9a of the substrate 9, the mirror 7 can be rotated smoothly. Furthermore, a silicon nitride film is deposited over the entire surface of the substrate 9 where the concave portion 9a is formed by chemical-vapor deposition (CVD), and the silicon nitride film in a region excluding the concave portion 9a may be removed by etching.

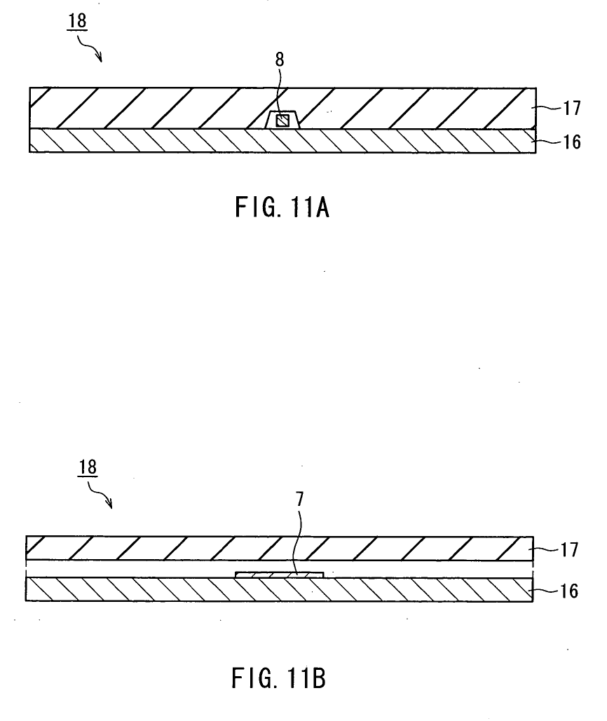

FIGS. 11A and 11B are cross-sectional views of a substrate 18 in which the substrates 16 and 17 are bonded to each other. The substrates 16 and 17 can be bonded to each other by direct bonding of semiconductors, bonding via a metal film (e.g., gold (Au) or a gold-tin alloy (AuSn), etc.), bonding via a resin (e.g., benzocyclobutene BCB), or the like.

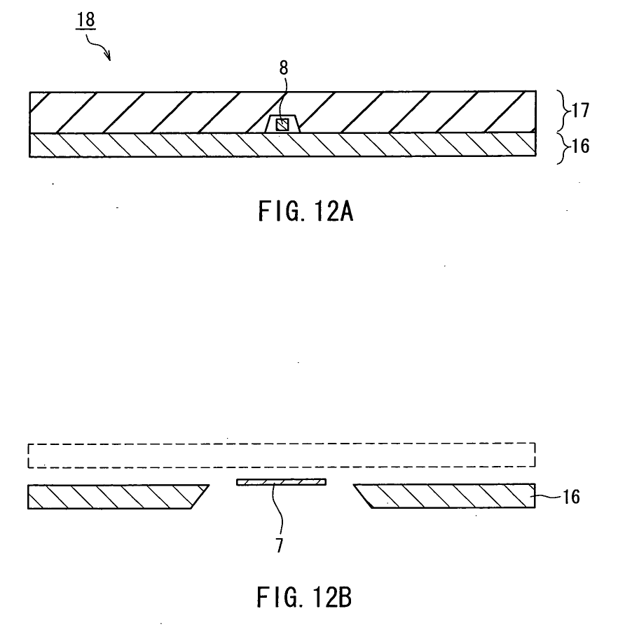

Next, as shown in FIGS. 12A and 12B, a portion excluding a part corresponding to the rotation shaft 8 and the concave portion 9a in the mirror 7 is etched from both surfaces with respect to the substrate 18 bonded in the bonding step shown in FIGS. 11A and 11B, whereby a through-hole is formed. More specifically, a photoresist is applied to the substrate 16 side and patterned by photolithography, and furthermore, silicon is etched in a KOH aqueous solution, using a mask obtained by patterning an oxide film. The mask is formed so that the reflective surface of the mirror 7 is exposed completely during etching in a potassium hydroxide (KOH) aqueous solution.

Then, regarding the substrate 17 side, silicon similarly is etched in a KOH aqueous solution.

At this time, the thickness of the substrate 16 is set to be equal to that of the substrate 17, and the substrate 18 is etched simultaneously from both sides, whereby a time for the mirror 7 to be exposed to the KOH aqueous solution can be shortened.

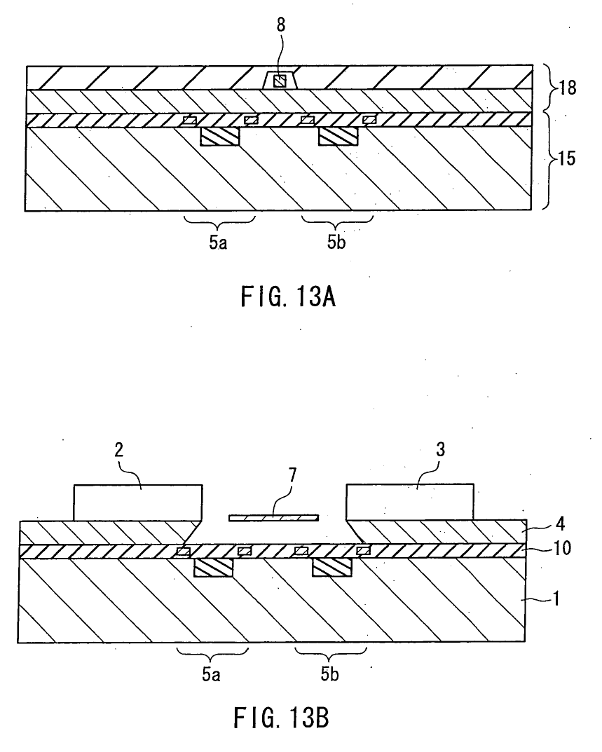

Finally, as shown in FIGS. 13A and 13B, the substrate 18 is bonded to the substrate 15, the substrates are formed into a chip by dicing, and the first laser chip 2 and the second laser chip 3 are mounted in a laser mounting portion, whereby a two-wavelength laser module is realized.

The mirror substrate 18 and the coil substrate 15 may be attached to each other after dicing.

Furthermore, at least one of the laser chips is composed of a monolithic type or hybrid type two-wavelength laser chip, whereby a multi-wavelength laser module compatible to at least three wavelengths can be produced.

In the step shown in FIGS. 13A and 13B, a hole is formed in the silicon substrate by etching. However, even if holes are previously formed in the respective substrates 16, 17 by etching in the step shown in FIGS. 9A and 9B and the step shown by FIGS. 10A and 10B, the same effect is obtained.

Furthermore, the rotation shaft 8 also can be composed of a beam (a fixing beam, a twisting beam) fixed to the substrate 4. However, it is preferable that the rotation shaft 8 is supported movably by the substrate 4 as in Embodiment 1 because the mirror 7 can be inclined at a desired angle and in addition, a required electric power can be reduced.

### Embodiment 2

1. Configuration of a Laser Module

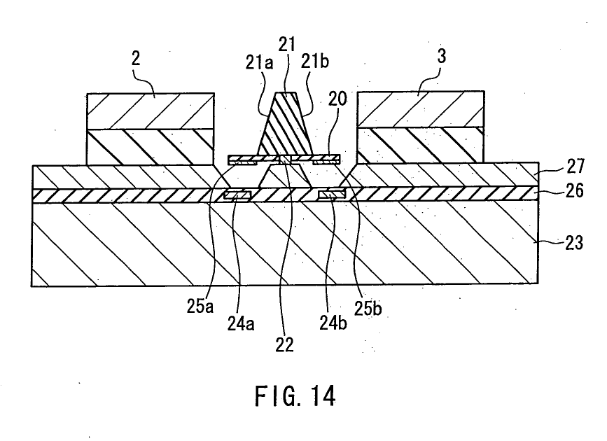

FIG. 14 is a cross-sectional view showing a configuration of a multi-wavelength laser module in Embodiment 2.

The wavelength laser module shown in FIG. 14 is composed of a substrate 23, a movable platform 20, a protruding mirror 21 forming a peak shape in cross-section provided on the movable platform 20, first electrodes 24a and 24b provided on the substrate 23, second electrodes 25a and 25b provided on a bottom surface of the movable platform 20, a first laser chip 20, and a second laser chip 21.

The laser chips 2 and 3 are placed so that output surfaces 2a and 3a are opposed to each other, and the protruding mirror 21 is placed between the laser chips 2 and 3. The movable platform 20 is held rotatably by a rotation shaft (beam) 22 extending in a direction at a right angle with respect to the opposed direction of the laser chips 2 and 3 and the vertical direction of the substrate 23.

The reflective surfaces 21a and 21b of the protruding mirror 21 are placed so as to form an arbitrary inclination angle with respect to the movable platform 20. The inclination angle of the movable platform 20 with respect to the substrate 23 can be changed by an electrostatic attraction force between the electrodes 24a and 25a and between the electrodes 24b and 25b provided on the bottom portion of the movable platform 20 and the substrate 23.

In the laser module shown in FIG. 14, there is a portion where an insulating layer and an oxide film are placed between layers, which is not shown for convenience sake.

2. Operation of a Laser Module

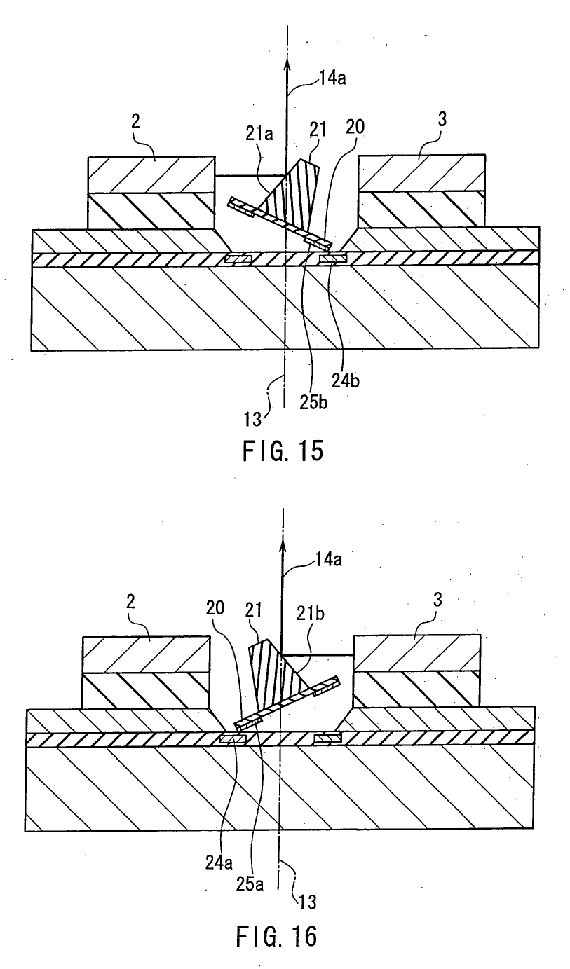

First, as shown in FIG. 15, when a voltage is applied to a first electrode 24b and a second electrode 25b so that the polarities thereof are opposite to each other, an electrostatic attraction force is generated between the first electrode 24b and the second electrode 25b. Then, the movable platform 20 is inclined toward the laser chip 3 side owing to the attraction force. At this time, if the application voltage is controlled so that the inclination angle of the protruding mirror 21 with respect to the axis of output light from the laser chip 2 is 45°, the output light from the laser chip 2 can be directed vertically with respect to the principal plane of the substrate 23. In FIG. 15, a light beam 14a reflected by a reflective surface 21a coincides with the principal axis 13.

On the other hand, as shown in FIG. 16, when a voltage is applied to the first electrode 24a and the second electrode 25a so that the polarities thereof are opposite to each other, an electrostatic attraction force is generated between the first electrode 24a and the second electrode 25a. Then, the movable platform 20 is inclined toward the laser chip 2. At this time, if the application voltage is controlled so that the inclination angle of the protruding mirror 21 with respect to the axis of output light from the laser chip 3 is 45°, the output light from the laser chip 3 can be directed vertically with respect to the principal plane of the substrate 23. In FIG. 16, a light beam 14b reflected by the reflective surface 21b coincides with the principal axis 13.

Although the movable platform 20 is in a state of floating in the air with respect to the substrate 23, the movable platform 20 can be integrated with the substrate 23 via the beam 22 (a support beam, a twisting beam). The beam 22 can be made of, for example, silicon, and can be produced concurrently with the formation of the movable platform 20. An appropriate restoring force can be generated in the movable platform 20 by the beam 22. Therefore, the electrostatic attraction force and the restoring force are balanced by controlling an application voltage, whereby the inclination angle of the movable platform 20 can be adjusted.

Furthermore, the wiring of the second electrodes 25a, 25b can be performed by forming metal wiring in the beam 22.

Furthermore, in the configuration in which the movable platform 20 is inclined with an electrostatic attraction force, for example, if the application of a voltage is stopped at a time when the first electrode 24 and the counter electrode 25 come into contact with each other via an insulating film 26 at a predetermined voltage or higher, the electrode 24 and the counter electrode 25 are pulled-in when they are attracted to each other with an attraction force. This enables the movable platform 21 (mirror) to be held at a predetermined angle.

In Embodiment 2, although the movable platform 21 is operated with an electrostatic attraction force, the movable platform 21 may be operated with a magnetic force as shown in Embodiment 1.

3. Method for Producing a Laser Module

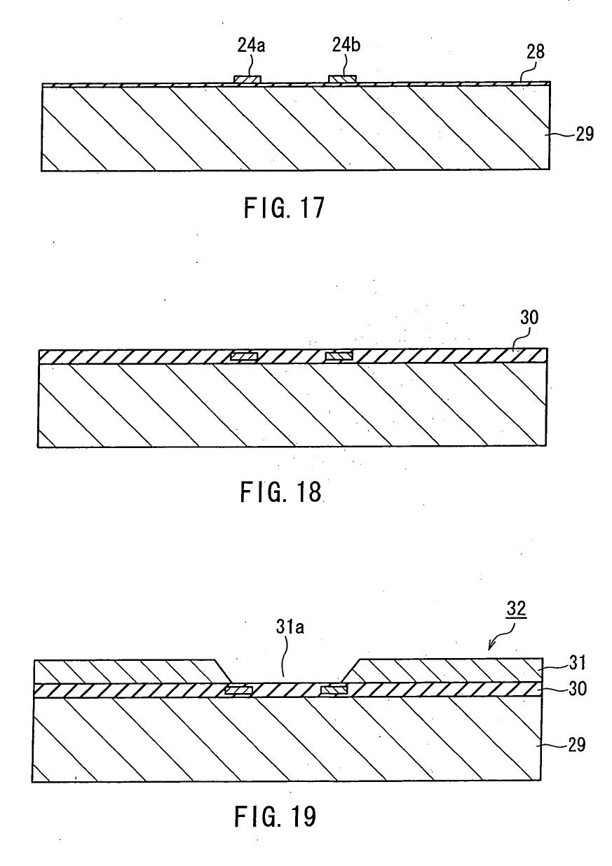

FIGS. 17 to 19 are cross-sectional views illustrating a method for producing a structure in which a first electrode is formed, and a mirror is floated in the air.

Hereinafter, unless otherwise specified, the principal plane of a semiconductor substrate is set to be a (001) plane, and the taper angle formed by anisotropic etching with a KOH aqueous solution is set to be about 54.7°, which is an angle formed with a (111) plane.

First, as shown in FIG. 17, an underlying insulating layer 28 is deposited on a semiconductor substrate 29 (e.g., a silicon substrate). The insulating layer 28 can be made of a silicon oxide film, a silicon nitride film, or a resin such as polyimide or BCB. After the insulating layer 28 is deposited, the electrodes 24a and 24b are formed. The electrodes 24a and 24b can be configured by depositing polysilicon, followed by patterning, or by depositing metal by electrolytic plating or vapor deposition.

Next, as shown in FIG. 18, an insulating layer 30 is deposited on the electrodes 24a and 24b so as to cover and insulate the electrodes 24a and 24b. The insulating layer 30 can be made of the same material as that for the insulating layer 28. The insulating layer 30 is deposited relatively thickly, and the surface thereof is flattened by chemical mechanical polishing (CMP).

Next, a substrate 31 is prepared. The substrate 31 is formed, for example, by coating a silicon substrate with a photoresist, forming a mask (e.g., a silicon oxide film) by photolithography and etching, and forming an opening 31a passing through the substrate by etching.

Next, as shown in FIG. 19, the substrate 29 and the substrate 31 are bonded to each other via the insulating layer 30. It is preferable that the insulating layer 30 is made of a resin such as BCB, and the substrate 29 and the substrate 31 can be bonded to each other satisfactorily. A substrate 32 produced by the bonding is referred to as an “underlying electrode substrate”.

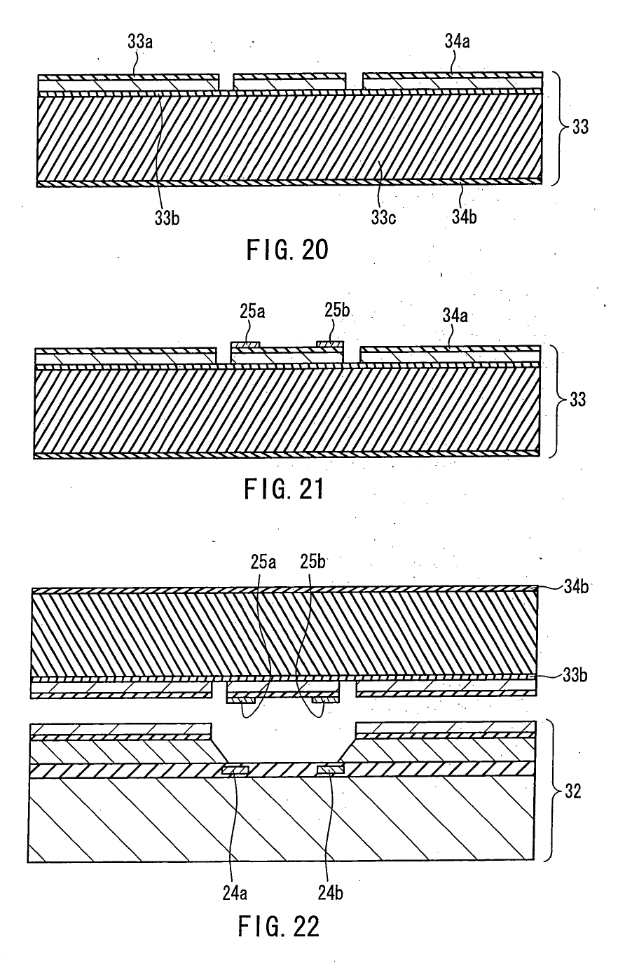

FIGS. 20 to 23 are cross-sectional views illustrating production steps of a movable mirror.

First, as shown in FIG. 20, a silicon-on-insulator (SOI) substrate 33 is composed of an SOI layer (Si device layer) 33a, a buried oxide film 33b, and a support substrate 33c. On both surfaces of the SOI substrate 33, insulating layers 34a and 34b are formed. Although the insulating layers 34a and 34b can be composed of a silicon oxide film, a silicon nitride film, or the like, a silicon nitride film is preferable.

The insulating layer 34a shown in FIG. 20 is patterned by photolithography and etching. The SOI layer 33a is etched, using the patterned insulating layer 34a as a mask. Consequently, the movable platform 20 (see FIG. 14) connected via the beam 22 is formed.

Next, as shown in FIG. 21, the second electrodes 25a and 25b are formed on the insulating layer 34a.

Next, FIG. 22 shows the step of bonding the SOI substrate 33 shown in FIG. 21 to the substrate 32 shown in FIG. 19 so that the first electrodes 24a and 24b are opposed to the second electrodes 25a and 25b. The bonding is performed by the same procedure as that of Embodiment 1. On the substrate 32, a support potion (not shown) supporting the beam 22 and the movable platform 20 is formed.

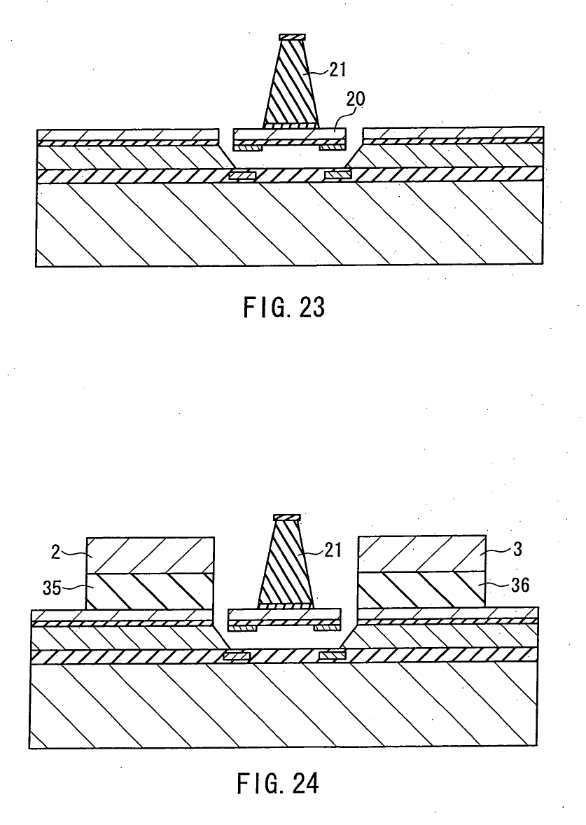

Next, FIG. 23 shows that the bonded substrate is subjected to anisotropic etching in a KOH aqueous solution, using a mask obtained by patterning the insulating layer 34b. Consequently, the protruding mirror 21 with a taper of about 54.7° is formed. The reaction of silicon etching stops at the buried oxide film 33b (see FIG. 22). If the buried oxide film 33b exposed in the stage where the reaction stops is removed with hydrofluoric acid (HF), the mirror 21 is supported movably by the beam 22.

In Embodiment 2, the movable platform 20 is operated using an electrostatic force as a drive source, so that the rotation shaft is composed of a twisting beam (support beam) having a restoring force. One side of the beam is fixed to the movable platform 20, and the other side thereof is fixed to the substrate 27.

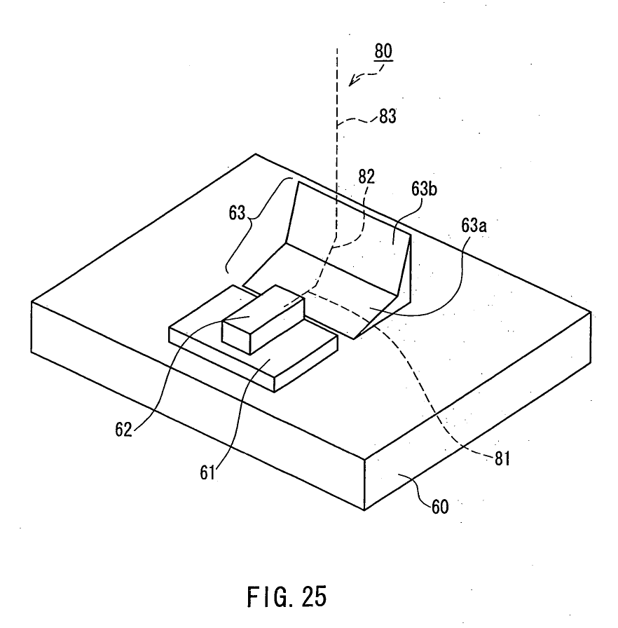

As shown in FIG. 24, if the first laser chip 2 and the second laser chip 3 are mounted on the substrate 32 respectively via bases 35 and 36, a multi-wavelength laser module is completed.

By adjusting the thicknesses of the bases 35 and 36, the optical axes of light beams emitted from the respective laser chips 2 and 3 can coincide with each other.

Furthermore, the bases 35 and 36 are useful as heat sinks for the respective laser chips 2 and 3.

Furthermore, it is desirable that the substrate 32 is formed into a chip by dicing before the laser chips 2 and 3 are mounted, and the laser chips 2 and 3 may be mounted on the substrate 32.

Furthermore, in FIG. 14, although an insulating layer and an oxide film placed between layers are not shown, an insulating layer and an oxide film are formed as described in the present embodiment.

### Embodiment 3

1. Configuration of a Laser Module

FIG. 25 is a perspective view of a laser device according to Embodiment 3.

In FIG. 25, the laser device is composed of a laser chip 62 mounted on a substrate 10 via a base 61 (a sub-mount, a gold (Au) bump, etc.) and a reflector 63 mounted on the substrate 10. The reflector 63 includes a first reflective surface 63a and a second reflective surface 63b connected to each other in a substantially sharply bent shape.

Laser light 80 travels along a first optical axis 81 to a third optical axis 83. In the laser light 80, a portion that is output from the laser chip 62 and reaches the first reflective surface 63a is referred to as a “first optical axis 81”. Furthermore, a portion that is reflected by the first reflective surface 63a and reaches the second reflective surface 63b is referred to as a “second optical axis 82”. Furthermore, a portion that is reflected by the second reflective surface 63b and output outside is referred to as a “third optical axis 83”.

The reflector 63 includes a first reflective surface 63a and a second reflective surface 63b capable of reflecting the laser light 80. The first reflective surface 63a is placed so as to reflect a luminous flux output from the laser chip 62 and traveling along the first optical axis 81 in a direction of the second reflective surface 63b. The second reflective surface 63b is placed so as to reflect the luminous flux reflected by the first reflective surface 63a and traveling along the second optical axis 82 in a direction vertical to the principal plane (or a first optical axis) of the substrate 60. Although the first reflective surface 63a and the second reflective surface 63b are smooth respectively, with each one side being in contact at a predetermined angle in the present embodiment, each one side is not necessarily required to be in contact, and may be placed with a predetermined gap therebetween.

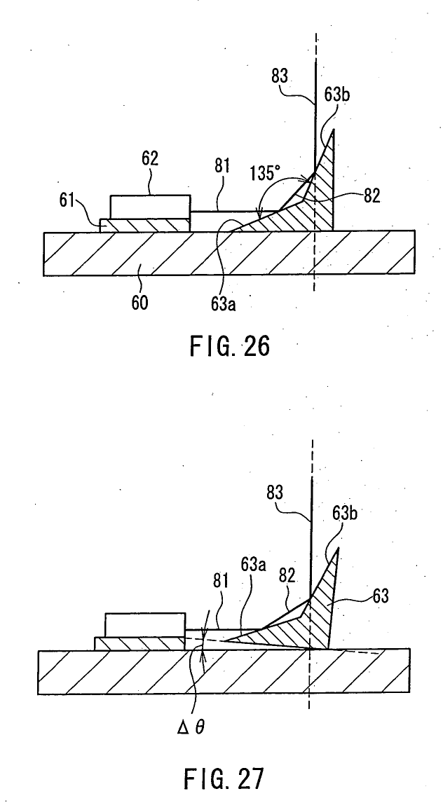

FIG. 26 is a cross-sectional view including the laser chip 62 and the reflector 63 in FIG. 25. An angle formed by the first reflective surface 63a and the second reflective surface 63b is set to be 135°. Furthermore, it is desirable that an angle formed by the first reflective surface 63a and the principal plane (or a first optical axis) of the substrate 10 is 22.5°. On the first optical axis 81, the first reflective surface 63a is placed, and the laser light reflected by the first reflective surface 63a travels along the second optical axis 82, is reflected again by the second reflective surface 63b, and travels along the third optical axis 83. It is desirable that the laser light that is output from the laser module and is incident upon an objective lens is collimated with a collimator lens or the like.

Herein, since the angle formed by the first reflective surface 63a and the second reflective surface 63b is set to be 135°, the angle formed by the first optical axis 81 (corresponding to incident light) and the third optical axis 83 (corresponding to output light) become 90°. The reflector 83 in which the angle formed by incident light and output light is invariable is known as, for example, a corner cube reflector (reflector in which three reflective surfaces are orthogonal to each other).

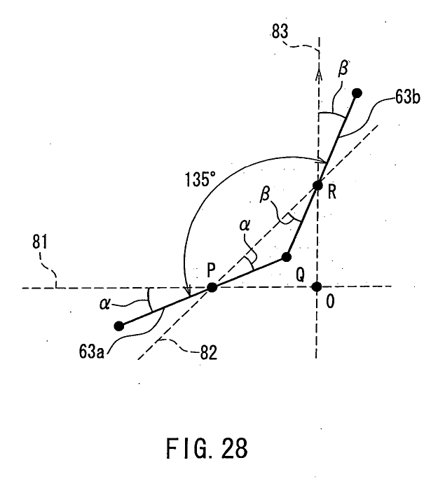

Next, the reason why the angle formed by incident light and output light is invariable in the reflector 83 will be described briefly. In FIG. 28, it is assumed that an angle formed by the first optical axis 81 and the first reflective surface 63a is α (incident angle, 90°−α), and an intersection therebetween is P. An angle formed by the second optical axis 82 and the second reflective surface 63b is β (incident angle, 90°−β), and an intersection therebetween is R. A contact point (intersection line) between the first reflective surface 63a and the second reflective surface 63b is Q. In this case, the sum of interior angles of ΔPQR is represented by α+β+135°=180°. Therefore, α+β=45°. An angle POR formed by the first optical axis 81 and the third optical axis 83 is represented by ∠POR=180−(2α+2β)=90°.

Thus, the rising angle (an angle formed by the first optical axis 81 and the third optical axis 83) uniquely is determined only by an angle formed by two reflective surfaces (an angle formed by reflective surfaces on an optical path flat surface) irrespective of α, β.

By setting the first reflective surface 63a and the second reflective surface 63b at a general angle (e.g., ζ), an angle δ formed by laser radiation light (first optical axis 81) and rising light (third optical axis 83) can be represented by δ=2(180°−ζ). Therefore, this also is effective for the case of deflecting light at a desired angle, without being limited to, for example, the case of setting the rising direction at 90° with respect the principal plane.

In the case of dealing with laser light having a finite beam width, in order to reduce the area of the reflective surface, and decrease the size of a reflector, it is desirable that the incident angle with respect to the first reflective surface 63a along the first optical axis 81 and the incident angle with respect to the second reflective surface 63b along the second optical axis 82 are set to be the same (α and β are set to be 22.5°).

As shown in FIG. 27, considering the case where the reflector 63 is set with an inclination shift of a minute angle Δθ, since the angle formed by the first reflective surface 63a and the second reflective surface 63b is set to be 135°, the angle formed by the first optical axis 81 and the third optical axis 83 is 90°.

More specifically, as long as the laser light is reflected once from the first reflective surface 63a and once from the second reflective surface 63b, no matter how the reflector 63 is placed, the angle formed by the first optical axis 81 and the third optical axis 83 is 90°, which is not influenced by the tilt angle (an amplitude of the third optical axis 83 with respect to the principal axis of the substrate).

Thus, by mounting the reflector 63 with the above-mentioned configuration, the laser light output from a laser chip can be directed in a direction of 90° with respect to the axis of output light without fail.

2. Method for Producing a Laser Module

Next, a method for producing the reflector 63 in which two reflective surfaces form an angle of 135° will be described.

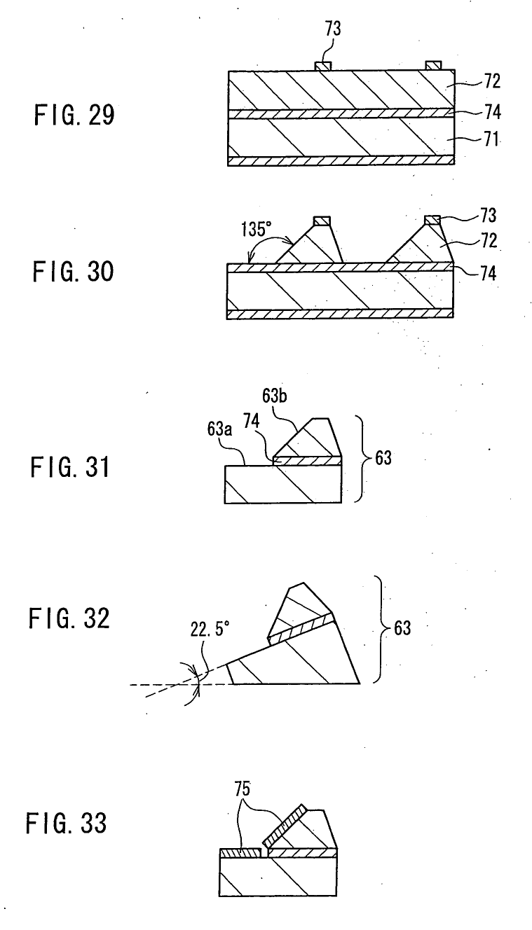

First, as shown in FIG. 29, a first silicon substrate 71 and a second silicon substrate 72 bonded to each other is produced. Both surfaces of these substrates are subjected to mirror grinding. A thermal oxide silicon film 74 is provided between the first silicon substrate 71 and the second silicon substrate 72. Such a substrate is known as a silicon-on-insulator (SOI) substrate. Herein, as the second silicon substrate 72, 9.7° off-angle substrate is used. The “9.7° off-angle substrate” refers to a silicon substrate in which a <001> crystal axis is off-angled by 9.7° in a <110> direction with respect to the principal plane of the substrate. FIG. 8 shows a (1-10) plane cross-section (surface parallel to an off-angle direction), and a mask, an etching surface, and the like are formed in a direction vertical to this surface.

Next, an oxide silicon film mask 73 is formed on the surface of the second silicon substrate 72.

Next, as shown in FIG. 30, the second silicon substrate 72 is etched in a potassium hydroxide (KOH) aqueous solution (e.g., concentration: 20 wt %; temperature: 80° C.), using the silicon oxide film mask 73 as a mask. In etching of silicon with a KOH aqueous solution, the etching rate of a (111) crystal plane is very low, so that a structure having a silicon (111) plane on a side surface is formed. The angle of the (111) plane with respect to the (001) plane is 54.7°, and 9.7° off-angle substrate is used, whereby one angle can be set to be 45°. The (111) plane has a mirror surface property, and can be used as an optical reflective surface. Furthermore, the etching rate of a silicon oxide film with a KOH aqueous solution is very low, so that the etching of the second silicon substrate 72 stops when the silicon oxide film 74 is exposed.

Next, as shown in FIG. 31, the exposed portion of the silicon oxide film 74 is removed completely with hydrofluoric acid (HF). Furthermore, the resultant layered body is subjected to dicing to a desired size so as to be used as the reflector 63. In this stage, the first reflective surface 63a that is a silicon (111) plane and the second reflective surface 63b that is a mirror-finished surface are formed. The angle formed by the first reflective surface 63a and the second reflective surface 63b is 135°.

As shown in FIG. 33, a reflective film 75 composed of a metal film, a dielectric multi-layered film, or the like is formed on the surfaces of the first reflective surface 63a and the second reflective surface 63b, whereby the reflectance can be enhanced. The metal film is composed of, for example, gold (Au), silver (Ag), aluminum (Al), or the like. Furthermore, the dielectric multi-layered film is composed of a layered film of silicon oxide (SiO₂), titanium oxide (TiO₂), or the like.

Next, as shown in FIG. 32, the diced reflector 63 is ground and polished while the reflective surface is being protected so that the bottom surface thereof forms an inclination angle of 22.5°. Because of this, the reflector 63 can be formed.

As described above, according to the present embodiment, the first and second reflective surfaces 63a and 63b are provided on the reflector 63 at a predetermined angle (135° in the present embodiment), and the laser light from the laser chip 62 is reflected by the first reflective surface 63a and the second reflective surface 63b to proceed. Thus, when the reflector 63 is mounted on the substrate 60, even if a variation in a positional size of the reflector 63 is caused, the variation can be absorbed, whereby a light beam output from the laser chip 62 can be directed vertically. This makes it unnecessary to correct the position of an optical axis in an optical system in a later stage, which used to be required conventionally. Consequently, it becomes easy to design an apparatus, and the miniaturization and the reduction in cost of a high-precision laser device can be realized.

### Embodiment 4

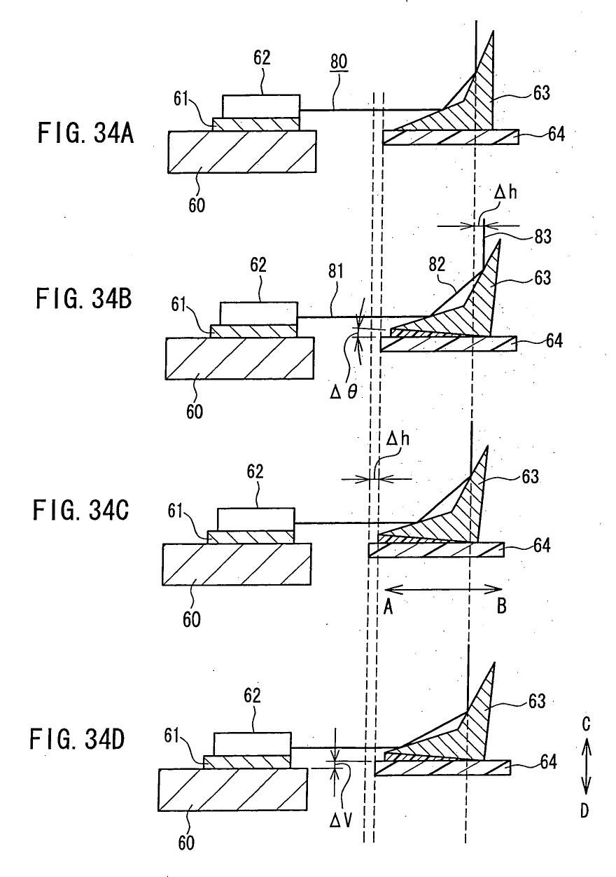

FIG. 34 is a cross-sectional view showing a configuration of a laser device in Embodiment 4. FIG. 34(a) shows a state in which a reflector is placed at a normal position; FIG. 34(b) shows a state in which the reflector is inclined at a minute angle; FIG. 34(c) shows a state in which an optical axis is corrected by moving a slide stage horizontally; and FIG. 34(d) shows a state in which an optical axis is corrected by moving the slide stage vertically.

In FIG. 34, the same components as those described in the previous embodiments are denoted with the same reference numerals as those therein, and the specific description thereof will be omitted. Embodiment 4 is characterized in that the reflector 63 is placed on a slide stage 64 (moving means) in the same configuration as that of Embodiment 3. The reflector 63 is fixed to the slide stage 64 with an adhesive or the like. Furthermore, the slide stage 64 can be produced using a micromachining technique.

The reflector 63 is placed on a principal plane of the slide stage 64, and can slide in a direction parallel to the first optical axis 81 as represented by an arrow A or B.

Hereinafter, an operation will be described.

In the case where the reflector 63 is mounted at a normal position, a luminous flux output from the laser chip 62 travels along an optical axis 80, as shown in FIG. 34(a).

However, the adhesion precision of the reflector 63 with respect to the slide stage 64 is low, and as shown in FIG. 34(b), in the case where the reflector 63 is placed so as to be inclined including an error (variation) of a minute angle Δθ in a radiation direction of laser light (inclination direction of the reflector 63), a tile angle is not influenced (that is, the third optical axis 83 is directed in a direction orthogonal to the first optical axis 81); however, the horizontal position of the third optical axis 83 is shifted by Δh in the radiation direction of laser light (direction of the first optical axis 81).

As shown in FIG. 34(c), the slide stage 64 is moved horizontally by Δh in the radiation direction of laser light (direction represented by the arrow B) to set Δh to be 0, whereby an optical axis shift can be eliminated.

Furthermore, as shown in FIG. 34(d), even if the slide stage 64 is configured so as to slide in vertical directions (directions represented by arrows C and D), the position of the third optical axis 83 can be adjusted so that the optical axis shift as shown in FIG. 34(b) becomes 0. More specifically, the slide stage 64 is slid by ΔV in the direction represented by the arrow C from the state shown in FIG. 34(b), whereby, as shown in FIG. 34(d), the position in the horizontal direction of the third optical axis 83 (optical axis of rising light) can coincide with the position shown in FIG. 34(a) that is a reference position.

As described above, according to the present embodiment, the reflector 63 is provided on the slide stage 64 so as to slide in a direction parallel to the first optical axis 81, whereby the shift of an optical axis in the horizontal direction of the third optical axis 83 (rising light) occurring in the reflector 83 due to a mount error can be adjusted for a position in the horizontal direction, which enables positioning with high precision. This makes it unnecessary to correct the position of an optical axis in an optical system in a later stage. Consequently, it becomes easy to design an apparatus, and the miniaturization of a high-precision laser device can be realized.

Furthermore, even when the slide stage 64 is configured so as to slide in the vertical direction (direction parallel to the third optical axis), the same functional effect is obtained.

### Embodiment 5

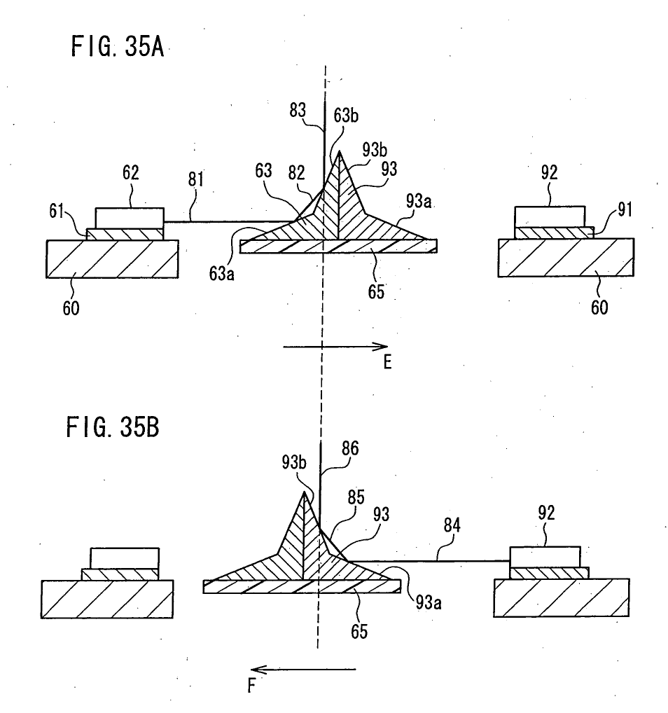

FIG. 35 is a cross-sectional view showing a configuration of a laser device in Embodiment 5.

In FIG. 35, the same components as those described in the previous embodiments are denoted with the same reference numerals as those therein, and the specific description thereof will be omitted. Embodiment 5 includes a second laser chip 92 provided on a second base 91, and a reflector 93 (having reflective surfaces 93a, 93b) placed opposed to the second laser chip 92, in addition to the configuration of Embodiment 3. The first laser chip 62 and the second laser chip 92 are placed so that output end surfaces are opposed to each other. The first reflector 63 and the second reflector 93 are placed on the slide stage 65 that can slide in directions represented by arrows E and F. As described in Embodiment 1, a mounting shift of the first reflector 63 and the second reflector 93 on the slide stage 65 do not influence the tilt angle of an optical axis.

Hereinafter, an operation will be described.

First, in the case of reflecting laser light output from the first laser chip 62 in a vertical direction, the slide stage 65 is slid in the direction represented by the arrow E to obtain a state shown in FIG. 35(a). Consequently, the laser light output from the first laser chip 62 is reflected by the first reflective surface 63a and the second reflective surface 63b of the reflector 63, and is output in the vertical direction. More specifically, the laser light output from the first laser chip 62 travels along the optical axes 81, 82, and 83.

On the other hand, in the case of reflecting the laser light output from the second laser chip 92 in the vertical direction, the slide stage 65 is slid in the direction represented by the arrow F to obtain a state shown in FIG. 35(b). Consequently, the laser light output from the second laser chip 92 is reflected by the first reflective surface 93a and the second reflective surface 93b of the reflector 93, and is output in the vertical direction. More specifically, the laser light output from the second laser chip 92 travels along optical axes 84, 85, and 86.

Thus, the first reflector 63 and the second reflector 93 are moved in the directions represented by the arrows E and F by the slide stage 65, whereby the path of a luminous flux traveling along the optical axis 83 can coincide with the path of a luminous flux traveling along the optical axis 86.

As described above, according to the present embodiment, the paths of luminous fluxes output in the vertical direction from the first laser chip 62 and the second laser chip 92 can coincide with each other simply with high precision.

Furthermore, even in the case where an inclination shift in the optical axis direction occurs in the first and second reflectors 63 and 93 when the slide stage 65 is moved horizontally, the tilt angle of the optical axis is not influenced, so that the horizontal position of the third optical axes 83 and 86 does not vary.

Even if a horizontal positional shift occurs in the third optical axes 83 and 86, the slide amount of the slide stage 65 is controlled so as to cancel the positional shift, whereby the horizontal positional shift of the optical axis can be eliminated.

### Embodiment 6

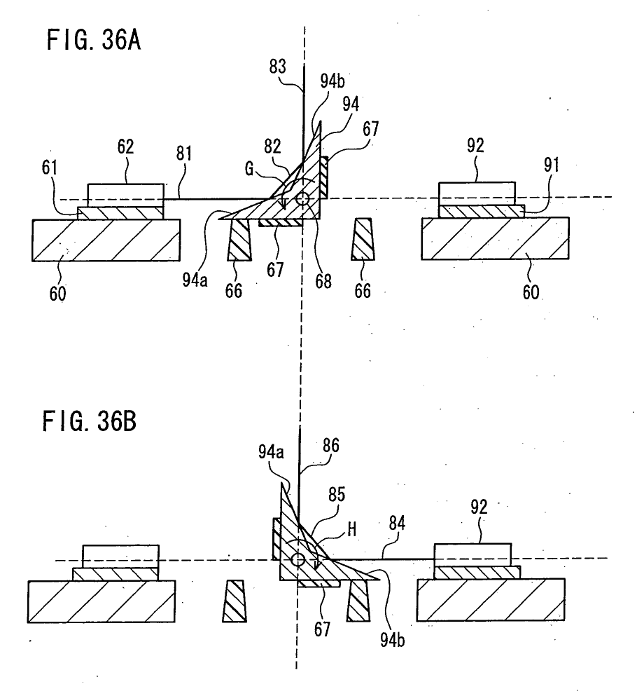

FIG. 36 is a cross-sectional view showing a configuration of a laser device in Embodiment 6.

In FIG. 36, the same components as those described in the previous embodiments are denoted with the same reference numerals as those therein, and the specific description thereof will be omitted. The first laser chip 62 and the second laser chip 92 are mounted on the substrate 60 via the bases 61 and 91. The output surfaces of the first laser chip 62 and the second laser chip 92 are placed so as to be opposed to each other horizontally, and a reflector 94 is placed on the first optical axes 81 and 84 that are axes of output light from the respective laser chips. The reflector 94 includes a first reflective surface 94a and a second reflective surface 94b connected to each other in a sharply bent shape. Abeam 68 (rotation beam) is connected to the reflector 94, and the reflector 94 is supported rotatably around the beam 68.

Hereinafter, an operation will be described.

First, in order to allow laser light from the first laser chip 62 to be output in a vertical direction, as shown in FIG. 36(a), the reflector 94 is rotated in the direction represented by an arrow G with respect to the beam 68 to obtain a first state. The reflector 94 in the first state is regulated for a position in a rotation direction by a stopper 66. In the first state, even if the inclination angle of the reflector 94 includes factors such as a variation (e.g., positional precision of a stopper, size precision), the tile angle of an optical axis is not influenced owing to the presence of the reflective surfaces 94a and 94b as shown in the present embodiment. Because of this, the laser light output from the first laser chip 62 travels along the optical axes 81, 82, and 83.

Next, in order to allow laser light from the second laser chip 92 to be output in a vertical direction, as shown in FIG. 36(b), the reflector 94 is rotated in the direction represented by an arrow H with respect to the beam 68 to obtain a second state. The reflector 94 in this state is regulated for a position in a rotation direction by the stopper 66.

In the first and second states, even if the inclination angle of the reflector 94 includes error factors such as a variation, the tilt angle of an optical axis is not influenced owing to the presence of the reflective surfaces 94a and 94b as shown in the present embodiment. Because of this, the laser light output from the second laser chip 92 travels along the optical axes 84, 85, and 86.

In the first and second states, the rotation center of the beam 68, the intersection between the first optical axis 81 and the third optical axis 83, and the intersection between the first optical axis 84 and the third optical axis 86 coincide with each other, whereby the third optical axes 83 and 86 can be made close to or coincide with each other with high precision.

The transition from FIG. 36(a) to FIG. 36(b) or vice versa can be realized, for example, by allowing a magnetic substance 67 (permanent magnet) to adhere to the reflector 94, and switching it by a magnetism generating circuit (not shown) provided separately.

As described above, according to the present embodiment, laser light output from the first laser chip 62 and the second laser chip 92 and traveling along the third optical axes 83 and 86 can coincide with each other simply with high precision.

### Embodiment 7

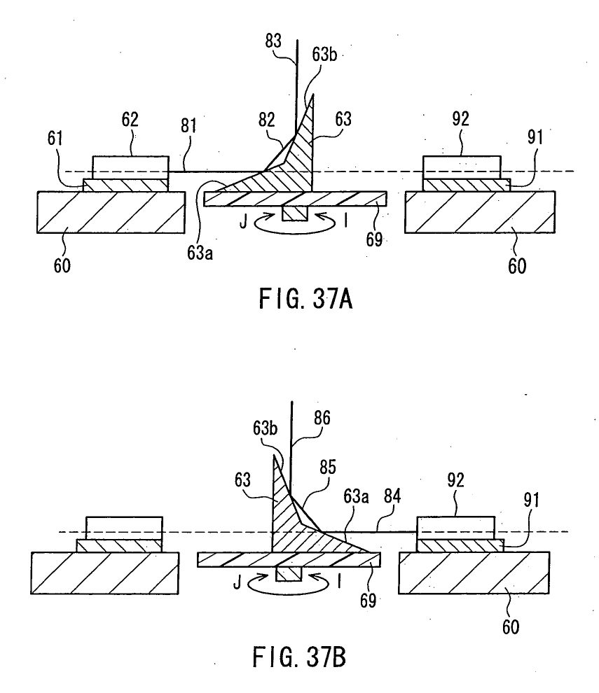

FIG. 37 is a cross-sectional view showing a configuration of a laser device in Embodiment 7.

In FIG. 7, the same components as those described in Embodiments 3-6 are denoted with the same reference numerals as those therein, and the specific description thereof will be omitted. The first laser chip 62 and the second laser chip 92 are mounted on the substrate 60 via the bases 61 and 91. The output surfaces of the laser chips 62 and 92 are placed so as to be parallel and opposed to each other.

The reflector 63 is placed so that the first optical axes 81 and 84 of laser beams output from the laser chips 62 and 92 cross the reflective surface 63a. Furthermore, the reflector 63 includes the first reflective surface 63a and the second reflective surface 63b connected to each other in a sharply bent shape. Furthermore, the reflector 63 is placed on a rotation stage 69. The rotation stage 69 can be produced by a micromachining technique. Even if a variation occurs in positional precision when the reflector 63 is fixed onto the rotation stage 69, the tilt angle of an optical axis is not influenced.

Hereinafter, an operation will be described.

First, in order to allow the laser light output from the first laser chip 62 to travel in a vertical direction, as shown in FIG. 37(a), the rotation stage 69 is rotated in a direction represented by an arrow I or J to obtain a first state. FIG. 37(a) shows a state in which the laser light output from the laser chip 62 is reflected by the reflector 63 to be raised in a vertical direction. Consequently, the laser light output from the first laser chip 62 travels along the optical axes 81, 82, and 83.

Next, in order to allow the laser light output from the second laser chip 92 to travel in a vertical direction, as shown in FIG. 37(b), the rotation stage 69 is rotated in a direction represented by an arrow I or J to obtain a second state. FIG. 37(b) shows a state in which the laser light output from the laser chip 92 is reflected by the reflector 63 to be raised in a vertical direction. Consequently, the laser light output from the second laser chip 92 travels along the optical axes 84, 85, and 86.

Furthermore, in the case where the rotation stage 69 performs precession, care should be taken as follows: unless the rotation amount of the rotation stage 69 is controlled so that an angle formed by the reflective surfaces 63a, 63b, when planes including the first, second, and third optical axes cut the reflector 63, becomes 135°, the tilt angle varies.

As described above, according to the present embodiment, the laser beams output from the first laser chip 62 and the second laser chip 92 and traveling along the third optical axes 83 and 86 can coincide with each other simply with high precision.

In the present embodiment, although the configuration in which two laser chips are provided has been described, at least three laser chips may be provided. This can be realized when all the laser chips are placed around a reflector so that output surfaces thereof are directed to the reflector, and the reflector is controlled so as to be opposed to all the laser chips based on the rotation control of the rotation stage.

### Embodiment 8

Embodiment 8 is an example in which a reflector is applied to radiation light (that is not collimated) having a predetermined spread angle. In order to collimate laser light, it is necessary to place a minute collimator lens with high precision between the laser chip and the reflector. Depending upon the design and production of a lens itself, and the mounting precision thereof, satisfactory collimated light is not always obtained.

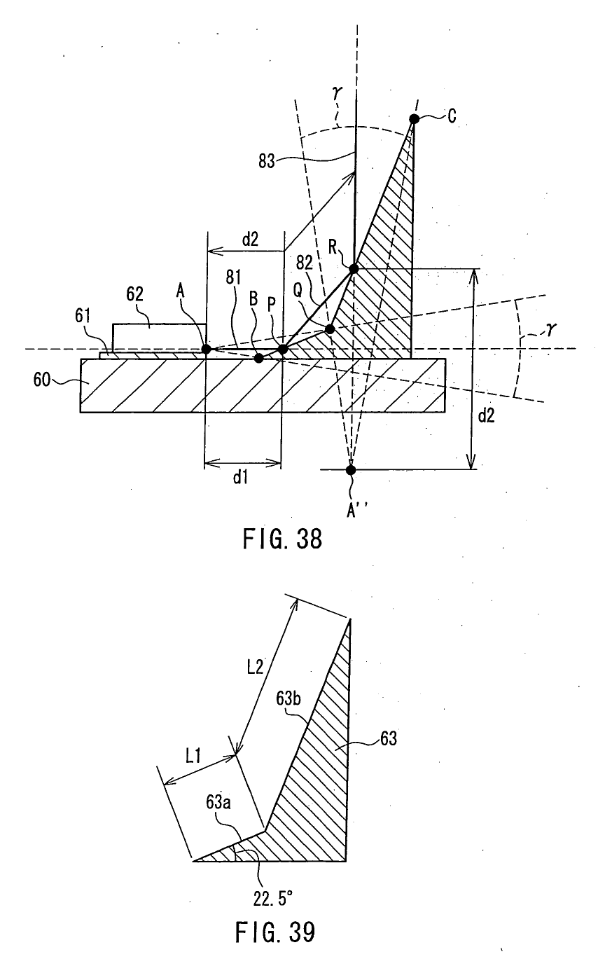

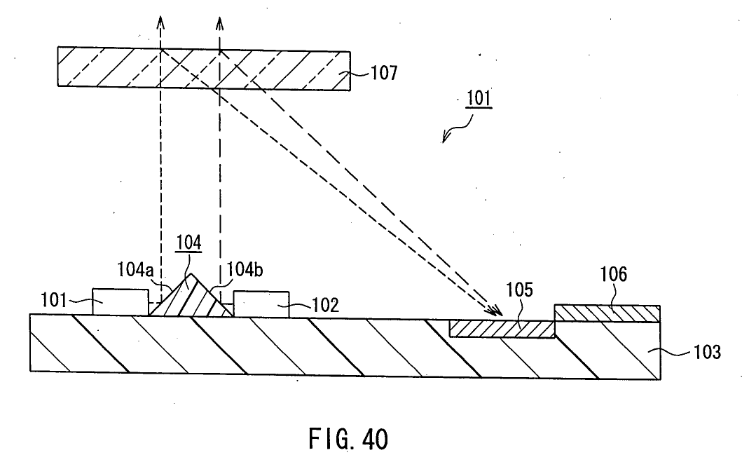

FIG. 38 is a cross-sectional view of a laser device of Embodiment 8, and FIG. 39 shows only the reflector 63 in FIG. 38.

It is desired that the size (length) of the reflective surface satisfies the following conditions with respect to the spread angle (angle γ) of laser light. The purpose of this is to control the generation of stray light or the loss of a luminous flux in a region in the vicinity of an intersection line (vicinity of an inflection point) of the reflective surfaces 63a and 63b.

It is assumed that end points of the first reflective surface 13a and the second reflective surface 13b (see FIG. 39) of the reflector 13 are B and C, respectively, and an intersection between the reflective surfaces 13a and 13b is Q. Furthermore, an intersection between the first optical axis 31 and the first reflective surface 13a is a first reflection point P, and an intersection between the second optical axis 32 and the second reflective surface 13b is a second reflection point R.

As shown in FIG. 38, the first reflection point P can be set so as to receive a maximum radiation light, irrespective of the opposed angle of the reflective surface (incident angle of laser radiation light with respect to the reflective surface), by applying a partition theorem of opposite sides by an angular bisector (BP:PQ=AB:AQ). As described above, regarding the reflector 63, in order to miniaturize the reflector 63, it is preferable that the reflective surface 63a is 22.5° with respective to the principal plane. The state satisfying this condition is assumed to be an ideal state.

Regarding the spread angle γ, the spread angle is estimated to be large, whereby laser light incident upon the intersection between the reflective surfaces 63a and 63b can be reduced, so that diffused reflection and the generation of stray light can be prevented.

As shown in FIG. 38, it is assumed that the distance between a light emitting point A of the laser chip 62 and a first reflection point P is d1, an optical length from the light emitting point A to a second reflection point R (length obtained by adding the distance between the first reflection point P and the second reflection point R to d1) is d2. The light emitting point A of the laser chip 62 is mirror-projected on an apparent light emitting point A″, and the distance from the apparent light emitting point A″ to the second reflection point R is d2. Furthermore, in the ideal state, ΔABQ is similar to ΔA″QC. Therefore, assuming that a length BQ of the first reflective surface 63a of the reflector 13 and a length QC of the second reflective surface 63b are L1, L2, respectively, considering the spread of radiation light of the laser chip 62 (it is assumed that the radiation light has a finite spread angle), when the following relationship holds among L1, L2, d1, and d2, the laser radiation light can be propagated with the loss of light amount minimized.
L2/L1≧d2/d1

Because of this, the size of the reflector can be miniaturized while the reflector of the present embodiment is used, even with respect to laser light having a finite spread angle (that is not collimated). The above condition is a calculation in the ideal state. Therefore, in an actual design, it is desired to provide a tolerance.

The multi-wavelength laser module according to the present invention can guide light output from a plurality of laser chips having different wavelengths into an information medium without an aberration, and is useful for an ultra-compact laser chip and an ultra-compact optical pick-up apparatus, compatible with a CD, a DVD, and an HD-DVD.

What is claimed is:

1. A multi-wavelength laser module, comprising:
a substrate;
a first laser element placed on the substrate;
a second laser element placed with an output surface opposed to the first laser element on the substrate; and
a reflector placed between the first laser element and the second laser element,
wherein the reflector has a reflective surface capable of reflecting output light from the first laser element or the second laser element in a predetermined direction, and
the reflector is provided so as to move or rotate between a first position capable of reflecting the output light from the first laser element and a second position capable of reflecting the output light from the second laser element.

2. The multi-wavelength laser module according to claim 1, wherein the reflector is placed rotatably, and
an angle at which the reflective surface rotates from a posture capable of reflecting the output light from the first laser element to a posture capable of reflecting the output light from the second laser element is at least 45°.

3. The multi-wavelength laser module according to claim 1, wherein the substrate has a bearing structure,
the reflector has a rotation shaft supported rotatably by the bearing structure, and
the reflector moves rotatably between the first position and the second position.

4. The multi-wavelength laser module according to claim 3, wherein the bearing structure is formed by bonding a first substrate to a second substrate, and
a concave portion receiving the rotation shaft is formed on at least one of the first substrate and the second substrate.

5. The multi-wavelength laser module according to claim 1, wherein the reflector is composed of a magnetic substance partially or wholly.

6. The multi-wavelength laser module according to claim 3, wherein the reflector is formed integrally with the rotation shaft, and
a width of the rotation shaft is formed so as to become large toward a portion close to the reflector.

7. The multi-wavelength laser module according to claim 3, wherein the substrate has a protrusion with an inclined surface in a lower part of the reflector, and
the reflector is in surface contact with the inclined surface when the reflector is placed at the first position or the second position.

8. The multi-wavelength laser module according to claim 4, wherein a low-friction material adheres to at least one of the bearing structure and the rotation shaft.

9. A multi-wavelength laser module, comprising:
a substrate;
a first laser element placed on the substrate;
a second laser element placed with an output surface opposed to the first laser element on the substrate;
a movable portion placed between the first laser element and the second laser element; and
a reflector in a protrusion shape that is placed in the movable portion and has reflective surfaces opposed to the output surfaces of the first laser element and the second laser element on both sides,
wherein the movable portion is configured rotatably so that reflected light which is output from the first laser element or the second laser element and reflected by the reflective surface is in an identical direction and has an identical optical axis.

10. The multi-wavelength laser module according to claim 9, wherein the substrate is configured by bonding a first substrate to a second substrate,
the movable portion, a beam, and the reflector are formed on the first substrate, and
a support portion supporting the beam and the movable portion is formed on the second substrate.

11. The multi-wavelength laser module according to claim 10, wherein the first substrate is made of silicon, and
the reflector is formed by crystal anisotropic etching.

12. A multi-wavelength laser module, comprising:
a laser element; and
a reflector configured by connecting a first reflective surface to a second reflective surface with an intersection line, and placed so as to reflect laser light output from the laser element by the first and second reflective surfaces,
wherein the reflector is placed at a position where the first reflective surface crosses a first optical axis of laser light output from the laser element, and the second reflective surface crosses a second optical axis of laser light reflected by the first reflective surface.

13. The multi-wavelength laser module according to claim 12, wherein an angle formed by the first reflective surface and the second reflective surface is 135°.

14. The multi-wavelength laser module according to claim 12, wherein an angle formed by the first reflective surface and the second reflective surface is 135° on a plane including the first optical axis and the second optical axis.

15. The multi-wavelength laser module according to claim 12, wherein the reflector is supported rotatably by a shaft,
the shaft is parallel to the first and second reflective surfaces,
a rotation axis of the shaft is positioned on the first optical axis, and
the rotation axis of the shaft further is positioned on a third optical axis of the laser light reflected by the second reflective surface.

16. The multi-wavelength laser module according to claim 12, wherein the reflector is placed on a rotatable rotation member, and
a rotation axis of the rotation member coincides with the third optical axis vertical to the first optical axis.

17. The multi-wavelength laser module according to claim 12, wherein the reflector is placed on a moving member movable in parallel with the first optical axis.

18. The multi-wavelength laser module according to claim 12, wherein the reflector is made of silicon,
the first reflective surface is composed of a silicon polished surface, and
the second reflective surface is formed by anisotropic etching.

19. The multi-wavelength laser module according to claim 12, comprising a plurality of laser elements,
the plurality of laser elements being placed with output surfaces of laser light directed to the reflector side.

20. The multi-wavelength laser module according to claim 12, wherein assuming that a distance between a light emitting point of the laser element and the first reflective surface is d1, and an optical path length from the light emitting point of the laser element to the second reflective surface is d2,
a ratio of a length of an intersection line where a plane including the second optical axis crosses the second reflective surface, with respect to a length of an intersection line where a plane including the first optical axis crosses the first reflective surface is at least d2/d1.
